(19) United States
(12) Patent Application Publication
(10) Pub. No.: US 2025/0252747 A1
(43) Pub. Date: Aug. 7, 2025

(54) CONCEPTS FOR MAINTAINING UPDATED IDENTITY RECORDS REFLECTING OBJECTS-OF-INTEREST ACTIVITY CAPTURED FROM A NETWORKED VIDEO RECORDER SYSTEM

(71) Applicant: LIVE REACH MEDIA INC, SUNNYVALE, CA (US)

(72) Inventors: DEAN MARQUEL WEBB, VENTURA, CA (US); NIMI WARIBOKO, JR., SAN FRANCISCO, CA (US)

(73) Assignee: LIVE REACH MEDIA INC, SUNNYVALE, CA (US)

(21) Appl. No.: 19/044,556

(22) Filed: Feb. 3, 2025

Related U.S. Application Data
(60) Provisional application No. 63/549,712, filed on Feb. 5, 2024.

(51) Int. Cl. G06V 20/52; G06T 7/70; G06V 10/44; G06V 10/56; G06V 10/82; H04N 7/18

(52) U.S. Cl. CPC G06V 20/52; G06T 7/70; G06V 10/44; G06V 10/56; G06V 10/82; H04N 7/18; G06V 2201/07

(57) ABSTRACT

Computer-implemented methods, apparatus, and computer program products are provided. In one embodiment, object-of-interest information/data corresponding to a proposed object-of-interest from a network camera is received. The object-of-interest information/data may be generated based on a surveillance-management record corresponding to one or more CCTV images input into the system, the records being automatically predicted from a neural engine corresponding to that object's activity on premise. The object-of-interest information/data also identifies tracking information and predicts multi-level characteristics for the proposed object-of-interest. In one embodiment, updated object-of-interest information/data is predicted, generated, maintained and updated, enabling a network video recorder system to transmit and display surveillance-management records via a surveillance-management software application based at least in part on one or more predictions in the event of an investigation

### BACKGROUND

Object reidentification is a critical aspect of surveillance systems, particularly in scenarios where tracking objects or individuals across multiple cameras or frames is necessary. In such surveillance systems, maintaining continuity in tracking objects or individuals as they move through different camera views or locations is crucial. Object reidentification allows systems to link and track the same object or person across various viewpoints, frames or cameras, ensuring seamless and efficient monitoring. Moreover, it significantly enhances security by enabling systematic monitoring of suspects or objects of interest as they move across different areas under surveillance or across various lengths of time. This capability enables effective identifying and tracking of objects of interest for business logistics, supply chain operations, potential threats, as well as suspicious activities. Object reidentification also assists in reducing false alarms or human errors in surveillance systems. By accurately recognizing and tracking objects, it minimizes misidentification and improves the reliability of the system's alerts/notifications. In this respect, when incidents occur, reidentification allows investigators to efficiently backtrack and trace the movements of individuals or objects involved, thus facilitating an accurate post-incident analysis where event reconstruction is necessary. In addition, surveillance systems equipped with effective reidentification capabilities optimize the use of resources such as data storage and compute power. Such systems may focus on storing and rendering relevant footage and information, reducing the need to cache terabytes of irrelevant background data, thus enhancing overall system efficiency and user experience. However, object reidentification faces challenges due to variations in lighting, object appearance, occlusions, and camera perspectives, making it a complex task in computer vision. Advancements in artificial intelligence and machine learning improve the accuracy and reliability of real-world reidentification systems. In essence, object reidentification is pivotal in surveillance systems, offering continuous tracking, bolstering security measures, enhancing accuracy, aiding investigations, and optimizing resource allocation for efficient monitoring and analysis.

### BRIEF SUMMARY OF THE DISCLOSURE

In the present invention, which claims the priority benefit to U.S. provisional patent application No. 63/549,712 under 37 CFR 1.78, describes an artificial intelligent CCTV integrated control agent control module formed between a plurality of CCTV modules for on-site use and a CCTV integrated management server manages, for example, a road traffic condition monitoring control function to be performed by the CCTV integrated control management server, CCTV integrated control center system with artificial intelligent CCTV integrated control mediation control module consisting of moving vehicle tracking function, traffic information analysis function, traffic information monitoring function, traffic information monitoring control, real time traffic information analysis and traffic signal control. When a CCTV camera has a wide area to be monitored, a CCTV system is used in which a plurality of surveillance cameras are installed at specific locations in a monitored area and the area is divided and displayed on one monitor screen. When the surveillance camera of more channels is connected, the surveillance camera is monitored and controlled by changing the video of the surveillance camera displayed on the screen periodically or selecting the surveillance camera displayed on the screen. The present invention relates to concepts for maintaining updated identity records associated with object-of-interest data and a system configured for object image recognition based at least in part on a CCTV image analysis apparatus, and more particularly, to a central processing unit (CPU) and/or graphics processing unit (GPU) capable of detecting/tracking objects of interest from a CCTV image. More particularly, to a CCTV image analysis apparatus based on an object image recognition network that performs robust and efficient image analysis using a Deep Convolutional Neural Network (DCNN). An object of the present invention is to provide a method and system for automatically monitoring a control area in real time without using surveillance personnel by applying a plurality of CCTV Deep Learning techniques, extracting a minutia vector of an image input and/or an object-of-interest input from a plurality of CCTVs, and to provide a deep learning-based CCTV image recognition system capable of tracking, monitoring and updating intrinsic feature representations of detected objects-of-interest in a form integrated with the plurality of CCTVs, a security system, and one or more customer/security personnel computing entities.

### BRIEF DESCRIPTION OF THE DRAWING(S)

Reference will now be made to the accompanying drawings, which are not necessarily drawn to scale, and wherein:

FIG. 1 is an exemplary schematic diagram of a system that may be used to practice various embodiments of the present invention.

FIG. 2 is an exemplary schematic diagram of a surveillance system in accordance with certain embodiments of the present invention.

FIG. 3 is an exemplary schematic diagram of a customer computing entity in accordance with certain embodiments of the present invention.

FIG. 4 is an exemplary schematic diagram of a network video recorder system in accordance with certain embodiments of the present invention.

FIG. 5 is an exemplary flow diagram indicating various processes performed for generating intrinsic feature representations for objects-of-interest and relevant information/data in accordance of an embodiment of the invention.

FIG. 6 is an exemplary depiction indicating various classification inferences performed for generating intrinsic feature representation models as a part of an embodiment of the invention.

FIG. 7 depicts another exemplary view showing a processing procedure and a result of an object tracking module that may be performed for maintaining updated identity records for objects-of-interest in accordance with various embodiments of the present invention.

FIG. 8 illustrates various stages of predictive operations in association with a processing procedure and a result of an object tracking module detecting an object-of interest in accordance with various embodiments of the present invention.

FIG. 9 illustrates another exemplary view of various stages of predictive operations in association with a processing procedure and a result of an object tracking module detecting an object-of-interest in accordance with various embodiments of the present invention.

FIG. 10 is an exemplary user interface screen incorporating queries and illustrative results from an identity-management system in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. And terms are used both in the singular and plural forms interchangeably. Like numbers refer to like elements throughout. Numerous specific details are set forth to provide a full understanding of the present disclosure. It will be apparent however, to one of ordinary skill in the art, that the embodiments of the present disclosure may be practiced without some of these specific details. In other instances, well-known structures and techniques have not been shown in detail so as not to obscure the disclosure.

The following concepts generally relate to methods, systems, and computer products for automatically generating identity records from one or more camera streams 130 in order to ensure that any object-of-interest is effectively maintained and/or updated, for example to automatically generate an alert/notification on the customer/security personnel's customer/security personnel computing entity 110. As will be recognized, this customer computing entity may be associated with the customer/security personnel via a corresponding customer/security personnel profile. In one embodiment, the security system (and/or other appropriately configured computing entity/entities) may obtain feature information/data for a proposed object-of-interest in order to predict/determine/identify an intrinsic feature representation to ensure the object-of-interest is incorporated in a customer/security personnel's computing entity 110. As will be recognized, the proposed object-of-interest may correspond to any item relevant for an investigative task (e.g. a proposed security threat or logistical item of interest to security personnel). Thus, in various embodiments, the feature information/data may comprise (1) the desired entrance date; (2) the object's location on the premises; and (3) the object's classification and/or feature representation, which may be determined automatically based on the predicted output of the present invention's neural engine module 140. This information/data may be provided to a customer/security personnel via a generated user interface, or it may be retrieved from another input source such as, for example, another software application executing on the customer/security personnel's customer computing entity, or by any other suitable method. For example, the system may retrieve feature information/data from a surveillance-management software application and/or a camera feed software application executing on the CCTV integrated control management server system 100.

Embodiments of the present invention may be implemented in various ways, including as computer program products that comprise articles of manufacture. Such computer program products may include one or more software components including, for example, software objects, methods, information/data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other information/data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A nonvolatile computer-readable storage medium may also include a punch card, paper tape,
optical mark sheet (or any other physical medium with patterns of holes or other optically recognizable indicia), compact disc read only memory (CD-ROM), compact disc rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magneto resistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

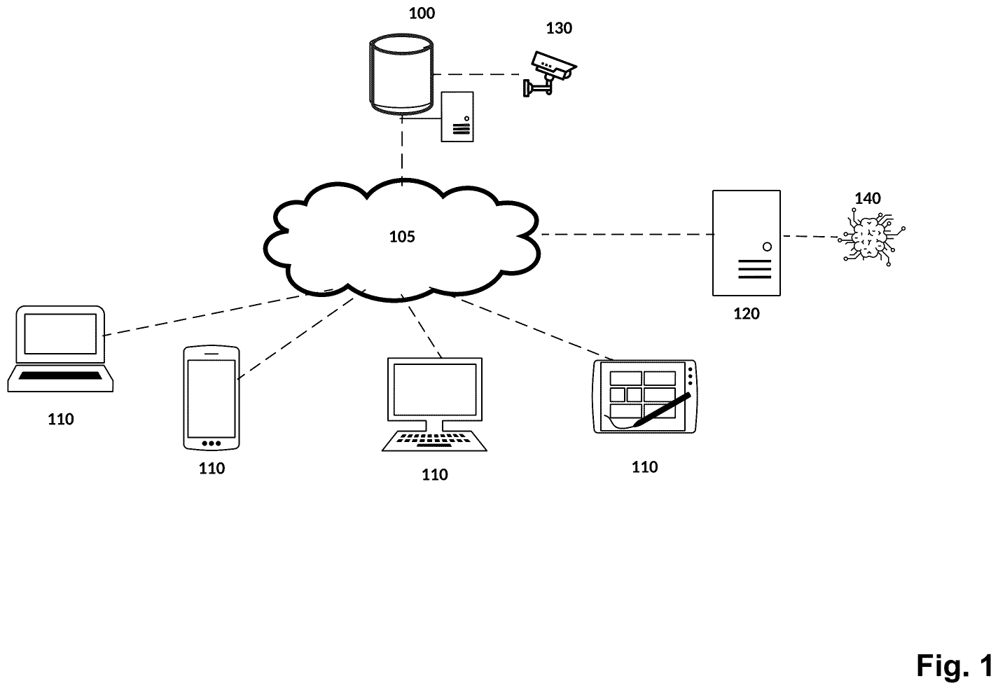

FIG. 1 provides an illustration of an exemplary embodiment of the present invention. As shown in FIG. 1, various embodiments may include one or more CCTV integrated control management servers 100, one or more networks 105, one or more cameras 130, one or more network video recorder systems 120, one or more neural engines 140, and one or more customer/security personnel computing entities 110. In one embodiment, any two or more of the illustrative components of the architecture of FIG. 1 may be configured to communicate with one another via respective communicative couplings to one or more networks 105. The networks 105 may include, but are not limited to, any one or a combination of different types of suitable communications networks and/or suitable communication interfaces, such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 105 may have any suitable communication range associated therewith and may include, for example, global networks (e.g., the Internet), metropolitan area networks (MANs), wide area networks (WANs), local area networks (LANs), or personal area networks. In addition, the networks 105 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities. Each of these components, entities, devices, systems, and similar words used herein interchangeably may be in direct or indirect communication with, for example, one another over the same or different wired or wireless networks and/or via any suitable communication interface. Additionally, while FIG. 1 illustrates the various system entities as separate, standalone entities, the various embodiments are not limited to this particular architecture.

### Exemplary CCTV Integrated Control Management Server System

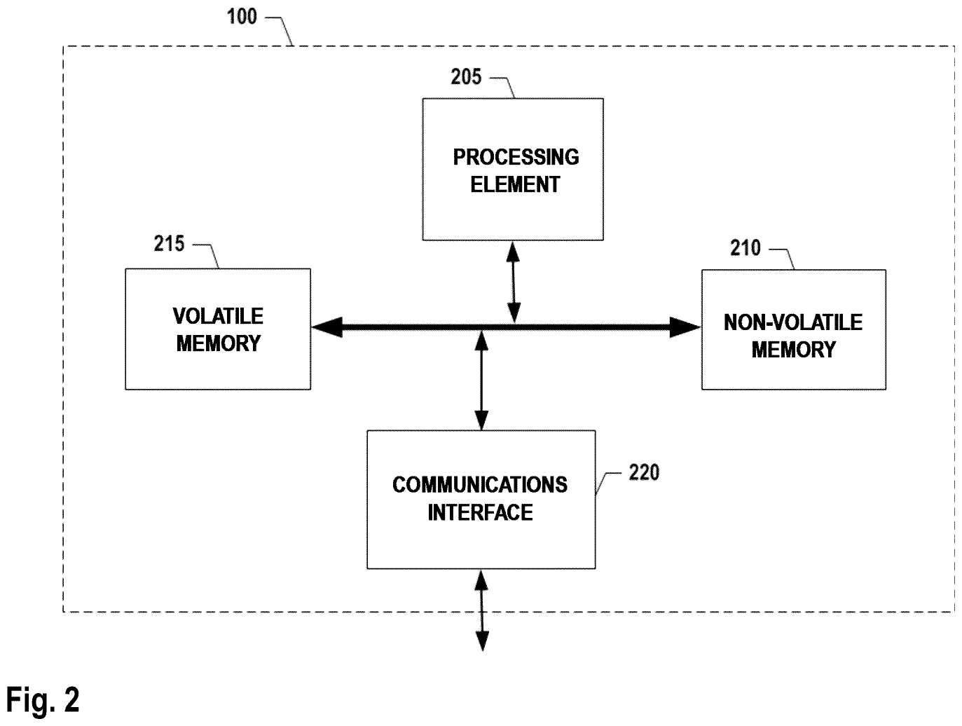

FIG. 2 provides a schematic of a CCTV integrated control management server system 100 according to one embodiment of the present invention. In general, the terms server, computing entity, computer, entity, device, system, and/or similar words used herein interchangeably may refer to, for example, one or more computers, computing entities, desktop computers, mobile phones, tablets, phablets, notebooks, laptops, distributed systems, dongles, items/devices, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the CCTV integrated control management server system 100 may also include one or more communications interfaces 220 for communicating with various computing entities, such as by communicating data, content, information, and/or similar terms used herein interchangeably that may be transmitted, received, operated on, processed, displayed, stored, and/or the like.

The CCTV integrated control management server system 100 may be operated by various entities, including security/surveillance personnel. As shown in FIG. 2, in one embodiment, the CCTV integrated control management server system 100 may include or be in communication with one or more processing elements 205 (also referred to as processors, processing circuitry, processing device, and/or similar terms used herein interchangeably) that communicate with other elements within the CCTV integrated control management server system 100 via a bus, for example. As will be understood, the processing element 205 may be embodied in a number of different ways. For example, the processing element 205 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the CCTV integrated control management server system 100 may further include or be in communication with non-volatile media (also referred to as non-volatile storage, memory, memory storage, memory circuitry and/or similar terms used herein interchangeably). In one embodiment, the non- volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, electronic task-management database, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like.

In one embodiment, the CCTV integrated control management server system 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the CCTV integrated control management server system 100 with the assistance of the processing element 205 and operating system.

As indicated, in one embodiment, the CCTV integrated control management server system 100 may also include one or more communications interfaces 220 for communicating with various computing entities, such as by communicating data, content, information, and/or similar terms used herein interchangeably that may be transmitted, received, operated on, processed, displayed, stored, and/or the like. Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the CCTV integrated control management server system 100 may be configured to communicate via wireless external communication networks (and/or via any suitable communication interface) using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced information/data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol.

Although not shown, the CCTV integrated control management server system 100 may include or be in communication with one or more input elements, such as a keyboard input, a mouse input, a touch screen/display input, motion input, movement input, audio input, pointing device input, joystick input, keypad input, and/or the like. The CCTV integrated control management server system 100 may also include or be in communication with one or more output elements (not shown), such as audio output, video output, screen/display output, motion output, movement output, and/or the like.

As will be appreciated, one or more of the security system's 100 components may be located remotely from other CCTV integrated control management server system 100 components, such as in a distributed system. Furthermore, one or more of the components may be combined and additional components performing functions described herein may be included in the CCTV integrated control management server system 100. Thus, the CCTV integrated control management server system 100 may be adapted to accommodate a variety of needs and circumstances. As will be recognized, these architectures and descriptions are provided for exemplary purposes only and are not limiting to the various embodiments.

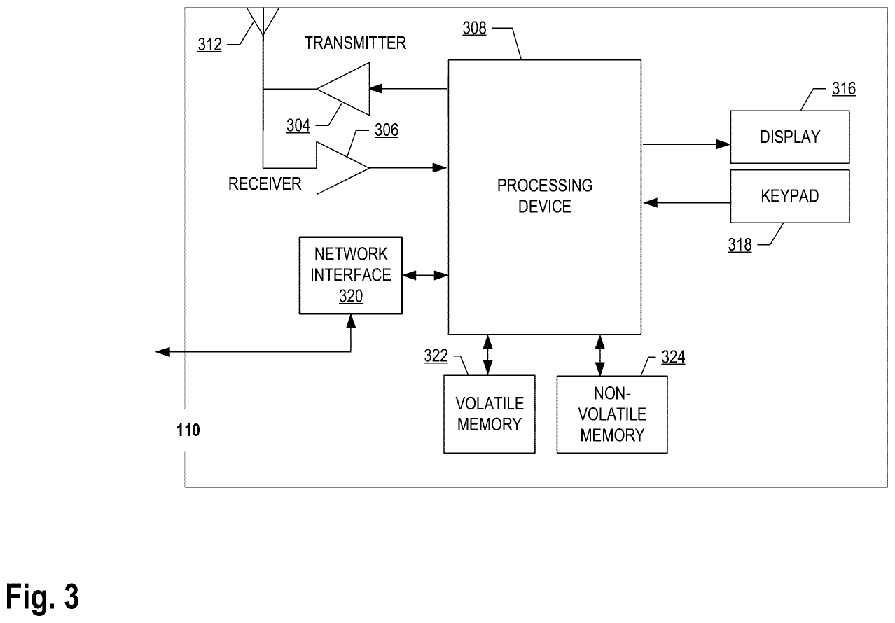

A customer/security personnel may be an individual, a family, a family member, a company, an organization, an entity, a department within an organization, a representative of an organization and/or person, and/or the like. Depending on the context, customers may be consignors/security personnel and/or consignees/recipients. Accordingly, the term customer may refer to both consignors/security personnel and/or consignees/recipients interchangeably. FIG. 3 provides an illustrative schematic representative of a customer/security personnel computing entity 110 (also referred to as a mobile device) that may be used in conjunction with embodiments of the present invention. In one embodiment, the customer computing entities 110 may include one or more components that are functionally similar to those of the CCTV integrated control management server system 100 and/or as described below. As shown in FIG. 3, a customer/security personnel computing entity 110 (also referred to herein interchangeably as the mobile device) may include an antenna 312, a transmitter 304 (e.g., radio), a receiver 306 (e.g., radio), and a processing element 308 that provides signals to and receives signals from the transmitter 304 and receiver 306, respectively.

The signals provided to and received from the transmitter 304 and the receiver 306, respectively, may include signaling information/data in accordance with an air interface standard of applicable wireless systems to communicate with various entities, such as vehicles, CCTV integrated control management server system 100, and/or the like. In this regard, the customer/security personnel computing entity 110 may be capable of operating with one or more air interface standards, communication protocols, modulation types, and access types. More particularly, the customer/security personnel computing entity 110 may operate in accordance with any of a number of wireless communication standards and protocols. In a particular embodiment, the customer/security personnel computing entity 110 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the customer/security personnel computing entity 110 may communicate with various other entities using concepts such as Unstructured Supplementary Service information/data (USSD), Short Message Service (SMS), Multimedia Messaging Service (MMS), Dual-Tone MultiFrequency Signaling (DTMF), and/or Subscriber Identity Module Dialer (SIM dialer). The customer/security personnel computing entity 110 may also download changes, addons, and updates, for instance, to its firmware, software (e.g., including executable instructions, applications, program modules), and operating system. For example, in one embodiment, the customer/security personnel computing entity 110 may store and execute a surveillance personnel application to assist in communicating with the surveillance personnel and/or for providing location services regarding the same.

According to one embodiment, the customer/security personnel computing entity 110 may include location determining aspects, devices, modules, functionalities, and/or similar words used herein interchangeably. For example, the customer/security personnel computing entity 110 may include outdoor positioning aspects, such as a location module adapted to acquire, for example, latitude, longitude, altitude, geocode, course, direction, heading, speed, UTC, date, and/or various other information/data. In one embodiment, the location module may acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the customer computing entity's 105 position in connection with a variety of other systems, including cellular towers, Wi-Fi access points, and/or the like. Similarly, the customer/security personnel computing entity 110 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, NFC transmitters, and/or the like. These indoor positioning aspects may be used in a variety of settings to determine the location of someone or something to within inches or centimeters.

The customer/security personnel computing entity 110 may also comprise a user interface (that may include a display 316 coupled to a processing element 308) and/or a user input interface (coupled to a processing element 308). For example, the user interface may be an application, browser, user interface, dashboard, webpage, and/or similar words used herein interchangeably executing on and/or accessible via the customer/security personnel computing entity 110 to interact with and/or cause display of information. The user input interface may comprise any of a number of devices allowing the customer/security personnel computing entity 110 to receive data, such as a keypad 318 (hard or soft), a touch display, voice/speech or motion interfaces, scanners, readers, or other input device. In embodiments including a keypad 318, the keypad 318 may include (or cause display of) the conventional numeric (0-9) and related keys (#, *), and other keys used for operating the customer/security personnel computing entity 110 and may include a full set of alphabetic keys or set of keys that may be activated to provide a full set of alphanumeric keys. In addition to providing input, the user input interface may be used, for example, to activate or deactivate certain functions, such as screen savers and/or sleep modes. Through such inputs the customer computing entity may collect contextual information/data as part of the telematics data.

The customer/security personnel computing entity 110 may also include volatile storage or memory 322 and/or non-volatile storage or memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory may store databases, database instances, database management system entities, data, applications, programs, program modules, scripts, source code, object code, byte code, compiled code, interpreted code, machine code, executable instructions, and/or the like to implement the functions of the customer/security personnel computing entity 110.

In another embodiment, the customer/security personnel computing entity 110 may include one or more components or functionality that are the same or similar to those of the CCTV integrated control management server system 100, as described in greater detail above. As will be recognized, these architectures and descriptions are provided for exemplary purposes only and are not limiting to the various embodiments.

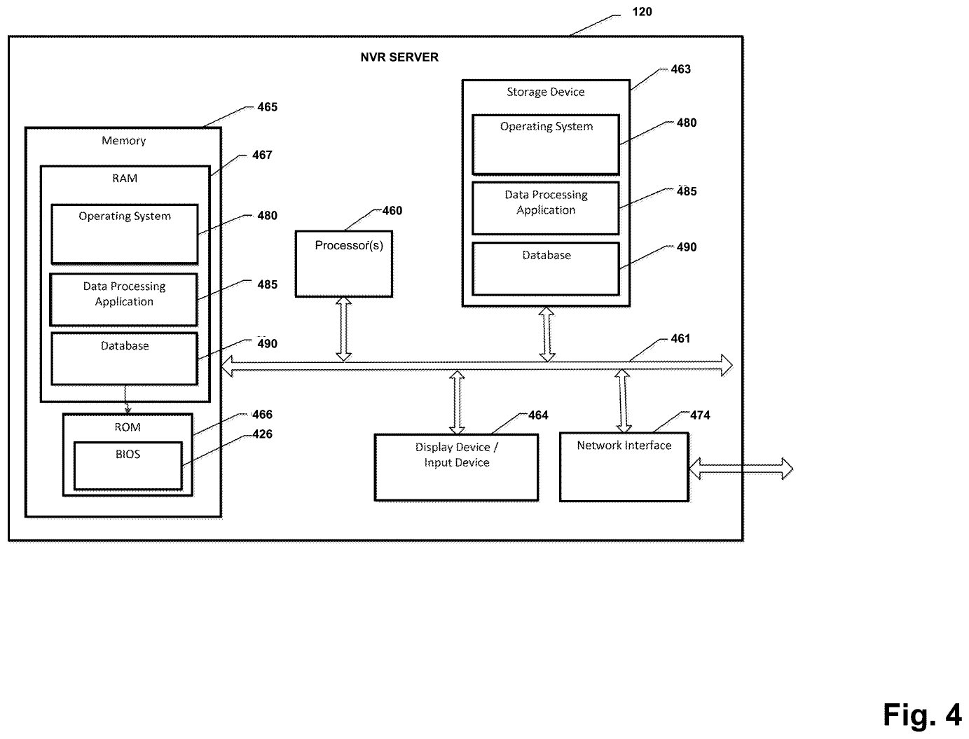

FIG. 4 provides a schematic of a network video recorder server 120 according to one embodiment of the present invention. In general, the terms network video recorder server, computing entity, computer, entity, device, system, and/or similar words used herein interchangeably may refer to, for example, one or more computers, computing entities, desktop computers, mobile phones, tablets, phablets, notebooks, laptops, distributed systems, dongles, items/devices, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

In certain embodiments, the plurality of one or more network cameras 130 are connected to the CCTV integrated control management server system 100 as well as the network video recorder 120 via the network 105.

Alternatively, in certain embodiments, the network video recorder server 120 is directly connected to a plurality of one or more network cameras 130, further comprising a network video recorder module, a PC workstation client running a client controller software enabled as an IP client station. The plurality of one or more network cameras 130 is connected to the network video recorder 120 without the addition of an external Ethernet switch. The IP client station is connected to the network video recorder through an uplink port that may be reached via a standard TCP/IP network. The network video recorder is connected to the IP client station either locally over a power over Ethernet (PoE) connection or remotely through a network router via Wi-Fi. The system is capable of connecting multiple video recorders to a local IP client station or to remote IP client station.

The network video recorder is comprised of a microprocessor, memory, BIOS flash memory, Solid State Disk Drive, SATA Hard Disk Drive and multiple Power over Ethernet (PoE) (IEEE 802.3af, 802.3at) enabled network interface ports. The number of network interface ports is preferably in configurations of 4, 8, 16 or 24 ports per recorder, the number of ports being limited only by the processing capability of the microprocessor and throughput of the memory, communications components, and Solid State Disk Drive.

In an embodiment, the network video recorder may be adapted to embed a layer2, Ethernet switch which then communicates with and coordinates signals to the network interface ports as wired RJ45 ports.

The network video recorder comprises Ethernet ports capable of accepting and recognizing cameras. The video recorder is comprised of a processor module, a heatsink and a surveillance personnel board. The processor module includes a microprocessor connected to memory. The processor module further comprises a system controller connected to a BIOS Flash. The surveillance personnel board includes at least one of group of multiple 10/100/1000 Base-T RJ-45 ports for the PoE connection, and multiple 10/100M Base-T RJ-45 ports. The surveillance personnel board further includes one 10/10/1000M RJ-45 port, one VGA (DB15) video monitor port, one E-SATA port and three USB 2.0 ports. Removable mass storage is operatively connected to the E-SATA port. Additionally, the surveillance personnel board includes an additional SATA port, an E-USB flash connector, a compact flash card socket, a system fan connector, and a power connector for a hard disk drive.

The network video recorder includes a control software, which when executed by the processor board, implements an automated “plug and play” mechanism, real-time video recording, video searches, video playback through a graphical user interface (GUI) and live video streaming from security devices.

The control software and operating system is stored on the solid state disk drive.

The video recorder supports all network cameras compliant with the ONVIF (Open Network Video Interface Forum) interoperability standard. The video recorder implements an automated “plug and play” capability for cameras connected through the PoE RJ-45 ports. Upon connection, all cameras are automatically powered, assigned an IP address, configured to a default video quality profile and recorded to hard-drive.

The automated “plug and play” capability requires no external network Ethernet switch or external power source. The automated “plug and play” capability is completely unattended, requiring no manual software, recorder or camera configuration steps or other user interaction.

The automated “plug and play” capability is implemented through control software instructions running on the processor module. The software provides an IP network discovery service for IP address assignment to the attached cameras. The software provides a library of software drivers to communicate and to provide configuration and video streaming instructions to the cameras attached to the RJ-45 ports. The software provides specific command and control instructions to the cameras for automated camera configuration. The automated camera configuration includes setting the features of video quality, video compression format, video frame-rate, time of day, motion detection configuration, motion sensitivity, and external I/O switching. In one embodiment, the IP network discovery service requests and downloads the library of camera software drivers from an internet server and configures the cameras using the software drivers.

The control software implements a video recording service to capture video streams from the RJ-45 ports. Video streams are stored on disk drives attached through an internal SATA connection, external SATA (eSATA) port or network attached storage (NAS) devices.

The control software implements a video streaming service to stream live and recorded video over RTP/TCP/IP to the IP client station via IP client controller software.

The control software supports an IP client controller software download, set up and initialization. The IP client controller software supports an automated client update service. Each time the client software is started from a remote PC, it will automatically check a web-based service to search, download and install software updates.

The control software in combination with the client software supports live viewing, PTZ control, camera tours and pre-defined camera views.

In use, the network video recorder receives instructions from the IP client station related to preferences of the user with respect to configuration of the network cameras. For example, camera choices, delay times, and PTZ parameters are selected through a graphic user interface produced by the client software operating on IP client station.

An IP network discovery service running on the network video recorder searches the network for available cameras connected at the RJ45 ports. Each Ethernet port controller associated to each RJ45 port reports specific connectivity data on a connected camera or other network security device including a fixed Mac-address which is stored in a SQL database. The network video recorder then configures each of the cameras, according to directions from the processor module, using camera specific data stored in the persistent memory (compact flash memory or mass storage device).

Once configured, the media recorder sets up streaming protocol channels to the cameras, and the event manager receives event and alarm data from the cameras including video streams and event transactions, according to instructions from the scheduler. Subsequently, video streams are stored in the media database and event/alarm transactions are stored in the SQL database via the mass storage device on the SATA port.

In certain embodiments, as will be understood from this figure, in one embodiment, the network video recorder server 120 may include a processor 460 that communicates with other elements within the network video recorder server 120 via a system interface or bus 461. The processor 460 may be embodied in a number of different ways. For example, the processor 460 may be embodied as one or more processing elements, one or more microprocessors with accompanying digital signal processors, one or more processors without accompanying digital signal processors, one or more co-processors, one or more multi-core processors, one or more 425 controllers, and/or various other processing devices including integrated circuits such as, for example, an application specific integrated circuit (ASIC), a field programmable gate array (FPGA), a hardware accelerator, and/or the like.

In an exemplary embodiment, the processor 460 may be configured to execute instructions stored in the device memory or otherwise accessible to the processor 460. As such, whether configured by hardware or software methods, or by a combination thereof, the processor 460 may represent an entity capable of performing operations according to embodiments of the present invention when configured accordingly. A display device/input device 464 for receiving and displaying data may also be included in or associated with the network video recorder server 120. The display device/input device 464 may be, for example, a keyboard or pointing device that is used in combination with a monitor. The network video recorder server 120 may further include transitory and non-transitory memory 465, which may include both random access memory (RAM) 467 and read only memory (ROM) 466. The network video recorder server's ROM 466 may be used to store a basic input/output system (BIOS) 26 containing the basic routines that help to transfer information to the different elements within the network video recorder server 120.

In addition, in one embodiment, the network video recorder server 120 may include at least one storage device 463, such as a hard disk drive, a CD drive, a DVD drive, and/or an optical disk drive for storing information on various computer-readable media. The storage device(s) 463 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EE-PROM), flash memory, hard disk, and/or the like. Additionally, each of these storage devices 463 may be connected to the system bus 461 by an appropriate interface.

Furthermore, a number of executable instructions, applications, scripts, program modules, and/or the like may be stored by the various storage devices 463 and/or within RAM 467. Such executable instructions, applications, scripts, program modules, and/or the like may include an operating system 480 and a data processing application 485. As discussed in greater detail below, this application 485 may control certain aspects of the operation of the network video recorder server 120 with the assistance of the processor 460 and operating system 480, although its functionality need not be modularized. In addition to the program modules, the network video recorder server 120 may store and/or be in communication with one or more databases, such as database 490.

Also located within and/or associated with the network video recorder server 120, in one embodiment, is a network interface 474 for interfacing with various computing entities. This communication may be via the same or different wired or wireless networks (or a combination of wired and wireless networks), as discussed above. For instance, the communication may be executed using a wired data transmission protocol, such as fiber distributed data interface (FDDI), digital subscriber line (DSL), Ethernet, asynchronous transfer mode (ARM), frame relay, data over cable service interface specification (DOCSIS), and/or any other wired transmission protocol. Similarly, the network video recorder server 120 may be configured to communicate via wireless external communication networks using any of a variety of protocols, such as 802.11, GSM, EDGE, GPRS, UMTS, CDMA2000, WCDMA, TD-SCDMA, LTE, E-UTRAN, Wi-Fi, WiMAX, UWB, NAMPS, TACS and/or any other wireless protocol.

In addition, in certain embodiments, a security program may be any program, group of programs, embedded software package, hardware, and/or cloud-based system that is designed for the end user for the purposes of initializing/recording/facilitating surveillance-management and investigation. For example, the surveillance-management program may correspond to and/or comprises: a to-do list application (e.g., Wunderlist, Todoist, Remember the Milk, etc.), a voice assistant application (e.g., Siri, Cortana, Google Now, etc.), a note-taking application (e.g., Evernote, OneNote, Apple Notes, etc.), an instant messaging application (e.g., iMessage, WhatsApp, Hangouts, Allo, Slack, etc.), a camera application, a database program, a word processor, a web browser, a spreadsheet application, a calendar application, a reminder application, an email client application, and/or the like.

In various embodiments, the surveillance-management program may store input from the end user in the form of surveillance-management information/data records. For example, surveillance-management program may comprise an internal database configured to store surveillance-management information/data records. Moreover, the surveillance-management program may comprise software to enable bidirectional access to such surveillance-management information/data records. For example, the surveillance-management program may comprise an application programming interface (API) that enables external software applications to download the contents of the surveillance-management information/data records by sending a structured query to a web-enabled controller of the API. In certain embodiments, the surveillance-management program may be in communication with one or more external software applications, and accordingly the surveillance-management program may be configured (e.g. via an API) to directly integrate/associate/communicate with the CCTV integrated control management server system 100, for example to initialize and transmit newly added electronic surveillance-management records to the CCTV integrated control management server system 100.

Additionally, in various embodiments, a neural network engine 140, may be connected to and/or integrated with the network video recorder server 120, serving as a pivotal component within the comprehensive system 120 for object detection, feature extraction, and re-identification. Moreover, the neural network engine 140 embodies a specialized computational framework amalgamating elements from established architectures known from one ordinary in the skill of the art, including YOLO (You Only Look Once), Transformers, RetinaNet, and/or their variants. The neural network engine 140 may further comprise a sophisticated arrangement of interconnected layers and modules, meticulously orchestrated to fulfill distinct functions vital to the detection, extraction, and re-identification of objects or individuals across surveillance imagery collected from the plurality of network cameras 130.

The neural network engine may further comprise a core architecture grounded in convolutional neural network (CNN) methodologies reminiscent of YOLO and RetinaNet frameworks. These foundational layers adeptly scan input images, utilizing grid-based or anchor-based approaches to localize and detect objects. Through hierarchical feature extraction, these layers discern intricate spatial details across various scales within the image, thus encapsulating a comprehensive representation of objects within the surveillance context.

Moreover, the neural network engine may comprise attention mechanisms akin to Transformer models such as CLIP, BLIP, Stable Diffusion, and ChatGPTV and/or all variants thereof, facilitating comprehensive and global contextual information processing. This attention mechanism may orchestrate effective feature representation, encompassing extensive information aggregation across disparate segments of the input data, thereby enriching feature extraction and fortifying the re-identification process.

Moreover, in certain embodiments of the present invention, complementing these elements, the neural network engine 140 comprises multi-layer perceptrons (MLPs) or fully connected layers, furnishing a framework to further process extracted features and encode distinct object identities. These layers may serve as a nexus, enabling the association and tracking of objects or individuals across diverse frames or disparate camera vantage points through learned and contrasted feature representations.

Diverse embodiments of this invention encompass tailored adjustments and enhancements to the neural network engine architecture. These enhancements may encompass nuanced modifications to layer configurations, deployment of distinctive activation functions, refinement of attention mechanisms, or fusion strategies amalgamating multiple facets of the network components. These refinements aim to elevate the accuracy of object detection, fortify the robustness of feature representation, and bolster the precision of re-identification across multifaceted surveillance scenarios.

In particular embodiments, the integration of YOLO, Transformers, RetinaNet, and analogous neural network architectures within the neural network engine fortifies its capacity to orchestrate efficient object detection, comprehensive feature extraction, and reliable re-identification across surveillance imagery. Consequently, this innovation propels advancements in security, surveillance, and object tracking realms.

More particularly, embodiments of the present invention may first encode the image input into a series of detected objects and feed them into a unified transformer encoder together with a corresponding image caption and multi-turn dialogue history input. The present invention may initialize the unified transformer encoder with BERT for increased leveraging of the pre-trained language representation. To deeply fuse features from the two modalities, the present invention make use of two visually-grounded pretraining objectives, such as Masked Language Modeling (MLM) and Next Sentence Prediction (NSP), to train the model on the visual dialogue data. In contrast to prior approaches involving MLM and NSP in BERT, the present invention additionally acquires the visual information into account for predicting a masked token or a next answer. Additionally, the present invention may employ different self-attention masks inside the unified transformer encoder to support both discriminative and generative settings. During inference, the present invention may directly either rank the answer candidates according to their respective NSP scores or generate an answer sequence by recursively applying the MLM operation. The ranking results may be further optimized using dense annotations provided by a ranking module.

In advantageous embodiments, the neural engine 140 may comprise a pretrained language model, such as CLIP or BERT, configured to effectively perform vision language tasks with predetermined fine-tuning for vision and dialogue fusion. The present invention achieves increased performance metrics in visual dialogue tasks using predetermined discriminative settings and predetermined generative settings against visual dialogue task benchmarks. The present invention provides several advantageous benefits over the prior approaches in visual dialogue by: 1) supporting both discriminative and generative settings whereas the prior approaches in visual dialogue are restricted to only pretraining with discriminative settings, and 2) not requiring to pretrain on large-scale external vision-language datasets as opposed to the prior approaches with inferior performance metrics. The present invention may be conducive in performing advantageously with various learning strategies, contexts, and dense annotation fine-tuning, thus facilitating future transfer learning research for visual dialogue.

As used herein, the term “network” may comprise any hardware or software based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks, such as supervised or unsupervised neural networks, convolutional neural networks, or memory-augmented neural networks, among others

### Exemplary Prediction-Based Alerts/Notifications

In certain embodiments, the CCTV integrated control management server system 100 (and/or other appropriately configured computing entity/entities) may automatically provide (e.g., generate, queue, and/or transmit) one or more prediction based notifications/messages based on the configurable/determinable parameters for a given account. For example, the CCTV integrated control management server system 100 (and/or other appropriately configured computing entity/entities) may automatically provide the prediction-based notifications/messages regarding items/object-of interests that may need to be provided to a surveillance personnel. As will be recognized, this may include generating, queuing, and/or transmitting an email message to a customer/security personnel's email address, a text message to a customer's cellular phone, a notification/message to a designated application, and/or the like based on the configurable/determinable parameters.

In one embodiment, to provide the prediction-based notifications/messages, the customer/security personnel computing entity 110, CCTV integrated control management server system 100, and/or a variety of other computing entities may perform prediction-based monitoring or determinations based on the configurable/determinable parameters for a given account. The prediction-based monitoring or determinations for entities and/or locations may be performed by an appropriate computing entity regularly, periodically, continuously, during certain time periods or time frames, on certain days, upon determining the occurrence of one or more configurable triggers/events, in response to requests, in response to determinations/identifications, combinations thereof, and/or the like. For example, an appropriate computing entity may monitor or determine/identify the locations of the various entities (e.g., item/object-of-interest 120, CCTV integrated control management server system 100, customer computing entities 110, and/or the like) and/or establishments/locations in response to certain triggers/events or requests. For example, the monitoring or determinations may only occur after surveillance-management items/object-of-interests have been processed. In such an example, the processing of a surveillance-management entry may trigger the setting a monitoring flag, initiate the monitoring, initiate a determination, and/or the like. Similarly, in one embodiment, the processing of a surveillance-management entry may trigger the automatic generation and queueing of one or more notifications/messages regarding the same. The notifications/messages may be automatically provided when the relevant configurable/determinable parameters are satisfied.

In one embodiment, the monitoring or determining/identifying may be initiated using a variety of different triggers. For examples, the triggers/events may include (a) a customer's customer/security personnel computing entity 110 being turned on or off; (b) an object-of-interest entering the premises and/or beginning to move; (c) an object of-interest moving out of a geofenced area; (e) an object-of-interest moving into a geofenced area; and/or a variety of other triggers/events. As will be recognized, a variety of other approaches and techniques may be used to adapt to various needs and circumstances.

In one embodiment, if a configurable trigger/event is not detected or a request is not received, an appropriate computing entity (e.g., CCTV integrated control management server system 100, customer/security personnel computing entity 110, and/or the like) may determine/identify whether a configurable time period has begun or ended. If the appropriate computing entity (e.g., CCTV integrated control management server system 100, customer/security personnel computing entity 110, a network video recorder server system 120 and/or the like) determines/identifies that the configurable time period has not begun or ended, the appropriate computing entity may continue monitoring for configurable triggers/events or requests. However, if the appropriate computing entity (e.g., CCTV integrated control management server system 100, customer/security personnel computing entity 110, a network video recorder server system 120 and/or the like) determines/identifies that the configurable time period has begun or ended, the appropriate computing entity may continuously monitor whether the relevant configurable/determinable parameters are satisfied. The monitoring may continue indefinitely, until the occurrence of one or more configurable triggers/events, until a configurable time period has elapsed, combinations thereof, and/or the like.

Generally, the locations of various entities (CCTV integrated control management server system 100, customer/security personnel computing entity 110, a network video recorder server system 120 and/or the like) may be monitored or determined/identified by any of a variety of computing entities-including CCTV integrated control management server system 100, customer/security personnel computing entity 110, a network video recorder server system 120 and/or the like. For example, the locations may be monitored or determined/identified with the aid of or in coordination with object-of-interest determining devices, object-of-interest determining aspects, object of-interest determining features, object-of-interest determining functionality, object-of interest determining sensors, and/or other object-of-interest determining services. Such may include camera-based predictions from the neural engine 140; lidar; radar; GPS; cellular assisted GPS; real time location systems or server technologies using received signal strength indicators from a Wi-Fi network and/or via any suitable communication interface); triangulating positions in connection with a variety of other systems, including cellular towers, Wi-Fi access points, and/or the like; and/or the like. Using these and other approaches and techniques, an appropriate computing entity (e.g., CCTV integrated control management server system 100, customer/security personnel computing entity 110, a network video recorder server system 120 and/or the like)) may determine, for example, whether and when entities are within a configurable/determinable distance threshold from one another and/or a known location.

In one embodiment, the configurable/determinable distance threshold may be a distance, range, zone of confidence, proximity, geofence, tolerance, and/or similar words used herein interchangeably. For example, in one embodiment, the configurable/determinable distance threshold may be plus or minus (±) a specific distance or range using a confidence-based thresholding system. As will be recognized, a configurable/determinable distance threshold may be in a variety of formats, such as degrees, minutes, seconds, feet, meters, miles, percentages and/or the like. Continuing with the above example, an appropriate computing entity may use a configurable/determinable distance threshold of ±0.000001, ±0.000001 in the DD coordinate system (or configurable/determinable distance/thresholds of ±0.000100, ±0.000100 or ±0.000010, ±0.000010) to determine and/or identify when configurable and/or determinable parameters for a customer are satisfied.

In the event such entities are within a configurable/determinable distance threshold from each other (e.g., associated with one another) or from a known/determined prediction in accordance with the configurable/determinable parameters, an appropriate computing entity (e.g., CCTV integrated control management server system 100, customer/security personnel computing entity 110, a network video recorder server system 120 and/or the like) may make this determination/identification and indicate or provide an indication of the same. The indication may include device/entity information/data associated with the corresponding customer/security personnel computing entity 110 and/or customer/security personnel computing entity 110, such as the corresponding device identifiers and names. The indication may also include other information/data, such as the location at which the establishments/locations and/or entities became within the configurable/determinable distance threshold of each other or a known/determined prediction, the time at which the entities became within the configurable/determinable distance threshold of each other or a known/determined prediction, the type of event (e.g., yelling, fighting, running, dropping off an item, and/or the like). In some embodiments, the appropriate computing entity may determine/identify the type of event. The appropriate computing entity (e.g., e.g., CCTV integrated control management server system 100, customer/security personnel computing entity 110, a network video recorder server system 120 and/or the like) may then store the information/data in one more records and/or in association with the account, subscription, program, and/or the like corresponding to the customer/security personnel.

The appropriate computing entity can also provide prediction-based notifications/messages in accordance with the corresponding notification/message preferences. In an embodiment, an appropriate computing entity may provide prediction-based notifications/messages when the configurable/determinable parameters are satisfied. For instance, when an appropriate computing entity determines/identifies that the configurable/determinable parameters for an account are satisfied, the appropriate computing entity may automatically provide appropriate prediction-based queued notifications/messages and/or automatically generate, queue, and transmit appropriate prediction-based notifications/messages in compliance with the corresponding notification/message preferences. By way of example, assume John is an object-of-interest and arrives within view of one or more of the plurality of network cameras 130 and is reidentified by neural engine 140 within a configurable/determinable distance/threshold (e.g., ±0.000001, ±0.000001) of the known intrinsic feature representation (e.g., a previous track id/representation stored in the database). An appropriate computing entity may make such a determination/identification based on the monitoring. In response, an appropriate computing entity (e.g., CCTV integrated control management server system 100, user computing entity 110, and/or the like) may automatically provide appropriate prediction-based queued notifications and/or messages; thus may automatically generate, queue, and transmit appropriate prediction based notifications/messages.

### Exemplary System Operation

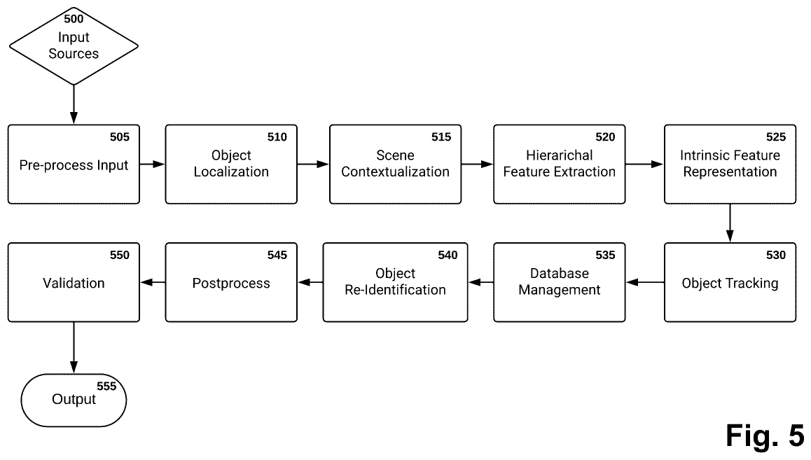

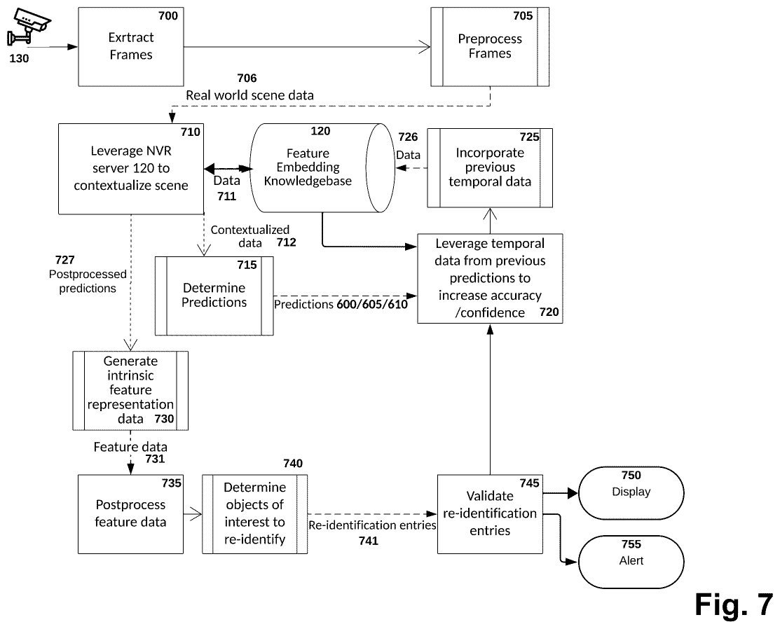

Reference will now be made to FIGS. 5, 6, 7, 8, 9, and 10. FIGS. 5 and 7 are flow diagrams illustrating operations, steps, and processes that may be performed for classifying an object-of-interest and/or incorporating a prediction-based intrinsic feature representation feedback system.

FIG. 5 is an exemplary high level flow diagram of a process for integrating automatic predictions with a surveillance-management program. As discussed herein, various embodiments of the present invention comprise an object-of-interest image recognition DCNN-based CCTV image analysis module with an input source unit 500. More particularly, a central processing unit (CPU); integrated with, for example the network video recorder server 120 and neural engine 140, capable of detecting/tracking objects of interest from a CCTV input source 500 may perform robust and efficient image analysis using a Deep Convolutional Neural Network (DCNN). The CCTV image analyzer module, which is the core of the intelligent CCTV video surveillance system, continuously obtains video frame data from a video providing apparatus such as a CCTV camera, a video streaming server, and the like connected to the image pre-processing unit 505. For example, when the surveillance system 100 connected to the network video recorder 120 comprises an IP camera 130, a video frame acquiring unit receives and decodes the encoded video stream data from the IP camera 130. Further, the system detects and tracks moving objects by receiving preprocessed video images 505 from CCTV cameras 130 and may automatically detect abnormal situations. The monitoring personnel can effectively monitor multiple CCTV camera images by checking only the CCTV images for which the alarm has occurred without having to constantly watch a large number of uneventful CCTV images. The video data is preprocessed 505 and transformed to a plurality of first video frames having a first pixel format, a first resolution and a first frame rate, from the video providing apparatus, The first resolution, the first frame rate, and the first pixel format are respectively referred to as a second resolution lower than the first resolution, a second frame rate lower than the first frame rate, An image converter for converting the first image data into a second image data of a different second pixel format having a different format is performed in the pre-process input 505 block.

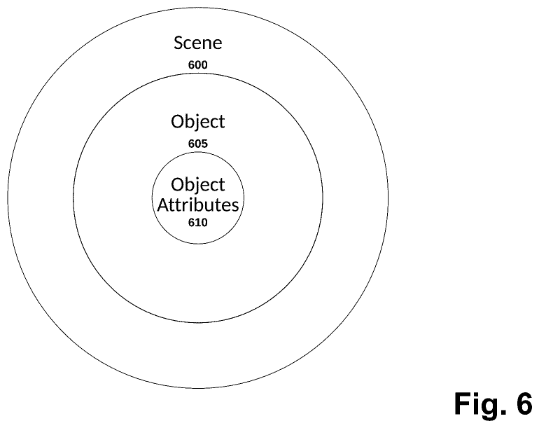

A plurality of tracking objects is detected and tracked 510, a plurality of images and/or image patches of the objects-of-interest being tracked are respectively extracted, and the plurality of tracking objects are identified using recognition results obtained by inputting the extracted object images to the DCNN. The scene contextualization module 515 may comprise: identifying a user non-interest object that is out of the plurality of tracking objects identified by the user and displaying to the user that an object-of interest is present in the scene. A tracked object classifier module 530 may additionally calculate and accumulate the first recognition result and the second recognition result as scores, respectively, and determine a class having the highest cumulative score as the type of the tracked object. Moreover, the tracked object classifier module 530 may calculate one or more objects belonging to the object of interest in a hierarchal manner such as the head, face, clothing of a human predicted class. In particular, the tracked object classifier may alternatively calculate one or more objects belonging to a vehicle class such as the vehicle color, make, model, year of manufacture, and/or license plate characteristics and associate such characteristics with the higher-level object class 525. The tracking object classification module 530 performs object classification using the object image recognition DCNN for the objects being tracked. Details related to the taxonomy of the tracking object classifying unit 525 will be described later with reference to FIG. 6. The neural engine 140 then extracts features of the image patch into a computer readable format such as a vector and stores the result in a database 535.

In FIG. 5, the object reidentification module 540 may comprise the steps of extracting a global feature map and partial attention maps (corresponding to attributes of the object-of-interest) to generate a global feature representation by using the neural engine 140, and fusing each partial attention map with the global feature map to form a fusion partial attention feature representation map; and forming a fusion global feature vector of each partial attention fusion feature map through a global average pool for example, and connecting all the fusion feature vectors into a global feature vector so as to perform postprocessing 545 re-identification by using the global feature vector. This result is then validated 550 by various techniques known to one of ordinary skill in the art, and output 555 to a display on the computing entity 110 and/or as the result of a query from the computing entity 110. Alternatively, the CCTV integrated control management server system 100 may periodically query the surveillance-management program for all the information/data updates since the last query and update all relevant data/information stored in the database integrated with the network video recorder server 120 and/or the like.

Reference will now be made to FIG. 6, which shows the classification types made by the neural engine 140. Block 600 relates to classification made of the entire scene. Block 605 relates to object-of-interest within the scene such as a pedestrian or a vehicle object.

Now turning to Block 610, once all relevant data/information has been determined and/or derived from the surveillance-management information/data 600 and 605, the neural engine may generate an electronic object-of-interest record within the scene comprising effective attributes of an object-of-interest relevant for reidentifying that object in a separate image at a later date or in an alternate view captured by another camera 130. The types of object attribute classifications that the neural engine 140 is configured to predict may comprise at least: a) age predictions, such as 1) age-over-60, 2) age-under-13, 3) age-under-16, 4) age-under-3, and 5) age-unknown; b) full-body apparel predictions, such as 1) apparel-style-casual, 2) apparel-style-formal, 3) apparel-style-sports fan, 4) apparel-style-suit, 5) apparel style-tight, 6) apparel-style-uniform, 7) apparel-style-unknown; c) lower body apparel predictions, 1) apparel-lower-bottom length-long, 2) apparel-lower-bottom length-short, 3) apparel-lower-bottom length-unknown, 4) apparel-lower-bottom style-bare, 5) apparel-lower-bottom style-casual, 6) apparel-lower-bottom style-dress, 6) apparel-lower-bottom style-formal, 7) apparel-lower-bottom style-jeans, 8) apparel-lower-bottom style-leggings, 9) apparel-lower-bottom style-long trousers, 10) apparel-lower-bottom style-pants-tight, 11) apparel-lower-bottom style-patterned, 12) apparel-lower-bottom style-ripped jeans, 13) apparel-lower-bottom style-shorts, 14) apparel-lower-bottom style-short skirt, 15) apparel-lower-bottom style-skirt, 16) apparel-lower-bottom style-slacks/dress pants, 17) apparel-lower-bottom style-stride, 18) apparel-lower-bottom style-striped, 19) apparel-lower-bottom style-sweatpants, 20) apparel-lower-bottom style-trousers, 21) apparel-lower-bottom style-unknown, 22) apparel-lower-color shade-dark, 23) apparel-lower-color shade-light, 24) apparel-lower-color-beige, 25) apparel-lower-color-black, 26) apparel-lower-color-blue, 27) apparel-lower-color-brown, 28) apparel-lower-color-green, 29) apparel-lower-color-multi, 30) apparel-lower-color-orange, 31) apparel-lower-color-other, 32) apparel-lower-color-pink, 33) apparel-lower-color-purple, 34) apparel-lower-color-red, 35) apparel-lower-color-silver/gray, 36) apparel-lower-color-unknown, 37) apparel-lower-color-white, 38) apparel-lower-color-yellow; d) upper apparel predictions, such as 1) apparel-upper-color shade-dark, 2) apparel-upper-color shade-light, 3) apparel-upper-color-beige, 4) apparel-upper-color-black, 5) apparel-upper-color-blue, 6) apparel-upper-color-brown, 7) apparel-upper-color-green, 8) apparel-upper-color-multi, 9) apparel-upper-color-orange, 10) apparel-upper-color-other, 11) apparel-upper-color-pink, 12) apparel-upper-color-purple, 13) apparel-upper-color-red, 14) apparel-upper-color-silver/gray, 15) apparel-upper-color-unknown, 16) apparel-upper-color-white, 17) apparel-upper-color-yellow, 18) apparel-upper-coverings-belt, 19) apparel-upper-coverings-blanket, 20) apparel-upper-coverings-bowtie, 21) apparel-upper-coverings-bracelet, 22) apparel-upper-coverings-coat, 23) apparel-upper-coverings-eyeglasses, 24) apparel-upper-coverings-gloves, 25) apparel-upper-coverings-hat, 26) apparel-upper-coverings-headphones, 27) apparel-upper-coverings-helmet, 28) apparel-upper-coverings-jacket, 29) apparel-upper-coverings-mask, 30) apparel-upper-coverings-necklace, 31) apparel-upper-coverings-none, 32) apparel-upper-coverings-religious garment, 33) apparel-upper-coverings-ring, 34) apparel-upper-coverings-safety vest, 35) apparel-upper-coverings-scarf, 36) apparel-upper-coverings-skullcap, 37) apparel-upper-coverings-sunglasses, 38) apparel-upper-coverings-tie, 39) apparel-upper-coverings-unknown, 40) apparel-upper-coverings-watch, 41) apparel-upper-sleeve length-long, 42) apparel-upper-sleeve length-short, 43) apparel-upper-sleeve length-unknown, 44) apparel-upper-top style-bare, 45) apparel-upper-top style-casual, 46) apparel-upper-top style-coat, 47) apparel-upper-top style-cotton, 48) apparel-upper-top style-dress shirt, 49) apparel-upper-top style-formal, 50) apparel-upper-top style-hoodie, 51) apparel-upper-top style-jacket, 52) apparel-upper-top style-logo, 53) apparel-upper-top style-long sleeve, 54) apparel-upper-top style-other, 55) apparel-upper-top style-plaid, 56) apparel-upper-top style-shirt, 57) apparel-upper-top style-spliced, 58) apparel-upper-top style-striped, 59) apparel-upper-top style-sweater, 60) apparel-upper-top style-t shirt, 61) apparel-upper-top style-unknown, 62) apparel-upper-top style-vest, 63) apparel-upper-top style-v neck; e) facial features, such as 1) facial features-beard, 2) facial features-makeup, 3) facial features-mask, 4) facial features-mustache, 5) facial features-none, 6) facial features-piercings, 7) facial features-religious markings, 8) facial features-shaved, 9) facial features-unknown, 10) face shape-average, 11) face shape-long, 12) face shape-round, 13) face shape-thin, 14) face shape-unknown; f) footwear such as 1)) footwear-bare, 2) footwear-boots, 3) footwear-boots-leather, 4) footwear-boots-sneakers, 5) footwear-boots-stilettos, 6) footwear-color-dark, 7) footwear-color-light, 8) footwear-color-unknown, 9) footwear-heels, 10) footwear-other, 11) footwear-sandals, 12) footwear-shoes-casual, 13) footwear-shoes-clothed, 14) footwear-shoes-fuzzy, 15) footwear-shoes-heels, 16) footwear-shoes-leather, 17) footwear-shoes-other, 18) footwear-shoes-skating/skiing, 19) footwear-shoes-sneakers, 20) footwear-shoes-sport, 21) footwear-slippers, 22) footwear-socks, 23) footwear-unknown; g) gender, such as 1) gender-female, 2) gender-male, 3) gender-unknown; h) hair characteristics, such as 1) hair-color-black, 2) hair-color-blonde, 3) hair-color-brunette, 4) hair-color-multi, 5) hair-color-red, 6) hair-color-silver/gray, 7) hair-color-unknown, 8) hair-color-white, 9) hair-length-bald, 10) hair-length-long, 11) hair-length-short, 12) hair-length-shoulder, 13) hair-length-unknown, 14) hair-style-afro, 15) hair-style-balding, 16) hair-style-braided, 17) hair-style-bun, 18) hair-style-buzzcut, 19) hair-style-down style, 20) hair-style-fade/cut, 21) hair-style-mullet, 22) hair-style-none, 23) hair-style-ponytail, 24) hair-style-shortcut, 25) hair-style-unknown, 26) hair-style-up style, 27) hair-type-coily, 28) hair-type-curly, 29) hair-type-none, 30) hair-type-straight-thick, 31) hair-type-straight-thin, 32) hair-type-unknown, 33) hair-type-wavy; i) heritage, such as 1) heritage-african, 2) heritage-ambiguous-mixed, 3) heritage-arabic, 4) heritage-asian, 5) heritage-caucasian, 6) heritage-indian, 7) heritage-latin, 8) heritage-unknown; j) physique, such as physique-average, 2) physique-long, 3) physique-round, 4) physique-small, 5) physique-thick, 6) physique-thin, 7) physique-unknown; k) possessions/accessories, such as 1) possessions-bag, 2) possessions-bag-backpack, 3) possessions-bag-briefcase, 4) possessions-bag-handbag, 5) possessions-bag-handbag/satchel, 6) possessions-bag-luggage; and I) object role, such as 1) role-clerk, 2) role-security, 3) role-student, 4) role-teacher, 5) role-customer; I) license plate serial data such as the state issues license plate serial numbers, which may be visible in images streamed from camera 130.

In light of the object attribute prediction types listed above, the neural engine 140 may predict a vector containing all aforementioned values each corresponding to a certain confidence level and store for each track id. The vector may then be compared with all other track ids to compute a match, such as with the cosine similarity and/or cosine distance technique known in the art.

Reference will now be made to FIG. 7. Blocks 700, 705, 710, 715, 720, 725, 730, 735, 740, and 745 incorporate predictive operations in association with a processing procedure and a result of an object tracking module detecting an object-of-interest in accordance with FIG. 5. Furthermore block 706 demonstrates the temporal frame preprocessing operation denoted in FIG. 5 that is leveraged by the network video recorder system 120.

The predictions 600, 605, 610 correspond to the object classification types denoted in FIG. 6. The feature embedding knowledgebase 120 stores feature data 731 as previously disclosed in FIG. 5 as the location of data/information 731 corresponding to the intrinsic feature representation highlighted in FIG. 5, block 535, which is processed in a machine-readable format to relay data/information 711 and 726 to the neural engine 140 via the network video recorder server 120. This data/information is processed as contextualized data 712 and later post processed as prediction data 727 after leveraging previous temporal data 725. Accordingly, when a customer/security personnel utilizes customer/surveillance personnel computing entity 110 for an investigative task, reidentification entries 741 are filtered based at least in part on a query from the customer and displayed 750. Alternatively, the customer/surveillance personnel computing entity 110 may proactively alert 755 a customer/surveillance personnel of a particular object of-interest and previously described.

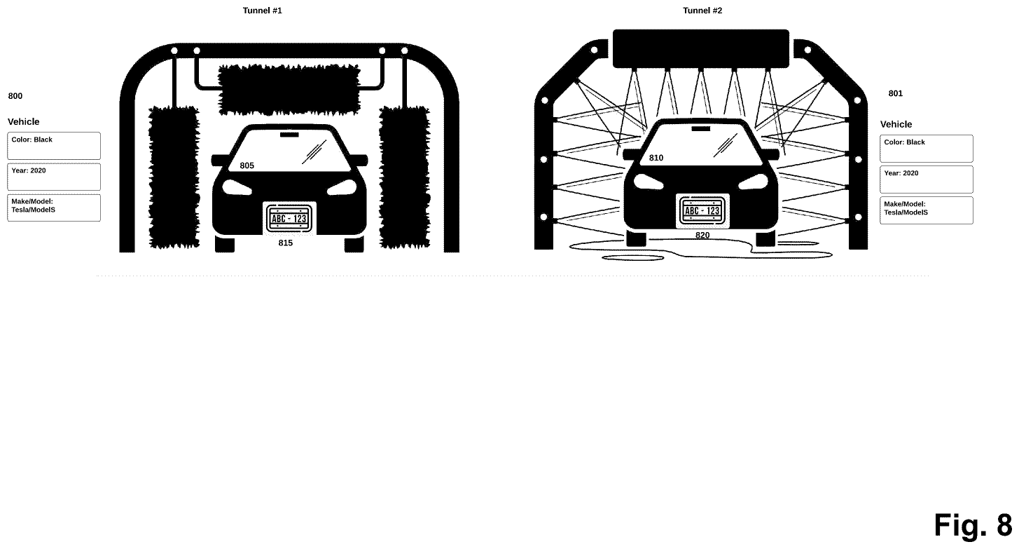

Now turning to FIG. 8, which illustrates a use case for re-identifying a vehicle, a site may have a plurality of IP cameras 130 configured to capture multiple tunnels at a carwash for example. In FIG. 8, images capturing Tunnel #1 feed frames into the neural engine, which detects vehicle 805 in accordance with multiple embodiments of the present invention. Furthermore, neural engine 140 predicts object attribute characteristics 800 such as the vehicle color, make, model, and year; as well as the license plate numbers 815, which is then recognized by neural engine 140 as displaying characters ‘ABC-123’. This data may later be re-recognized in Tunnel #2 as corresponding to vehicle 810. The neural engine 140 may then gather data from the embedding knowledge base and compare results to determine that vehicle 805 and 810 are in fact the same vehicle, this re-identification confidence is high and a match is displayed to the customer and/or alerted to the computing entity 110. Additionally and/or alternatively, the neural engine may determine re-identification by re-recognizing license plate 820 as a match to license plate 815, thus transmit the data/information back to computing entity 140 as well as store in the embedding knowledgebase, as previously described herein.

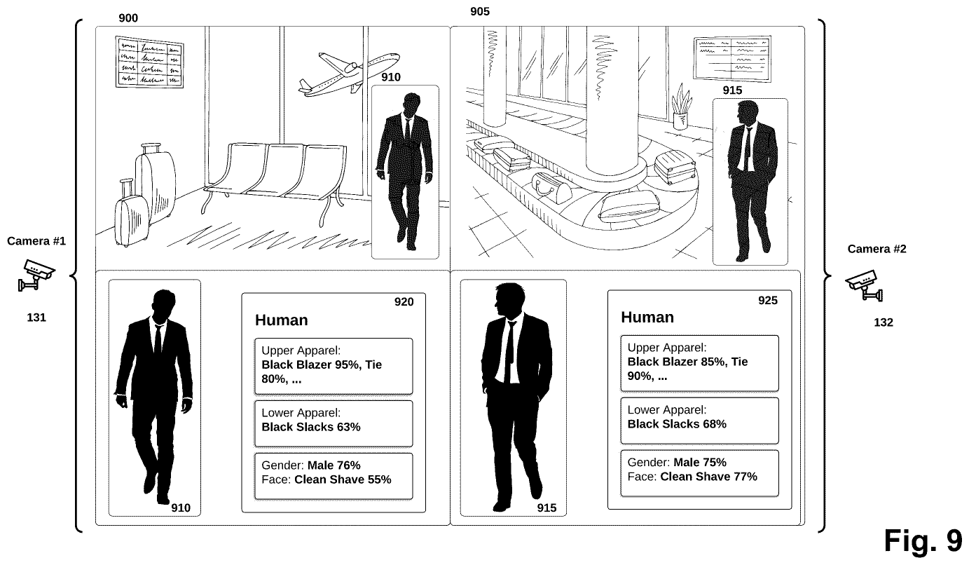

Similarly, in FIG. 9, a. camera 131 streams frames depicting scene 900, which is mostly background information until human prediction 910 is detected. Once the relevant information corresponding to human 900 is determined, it is then predicted to associated with human 915, captured by scene 905 and camera 132, as the same person by way of performing a distance threshold calculation between data/information 920 and 925.

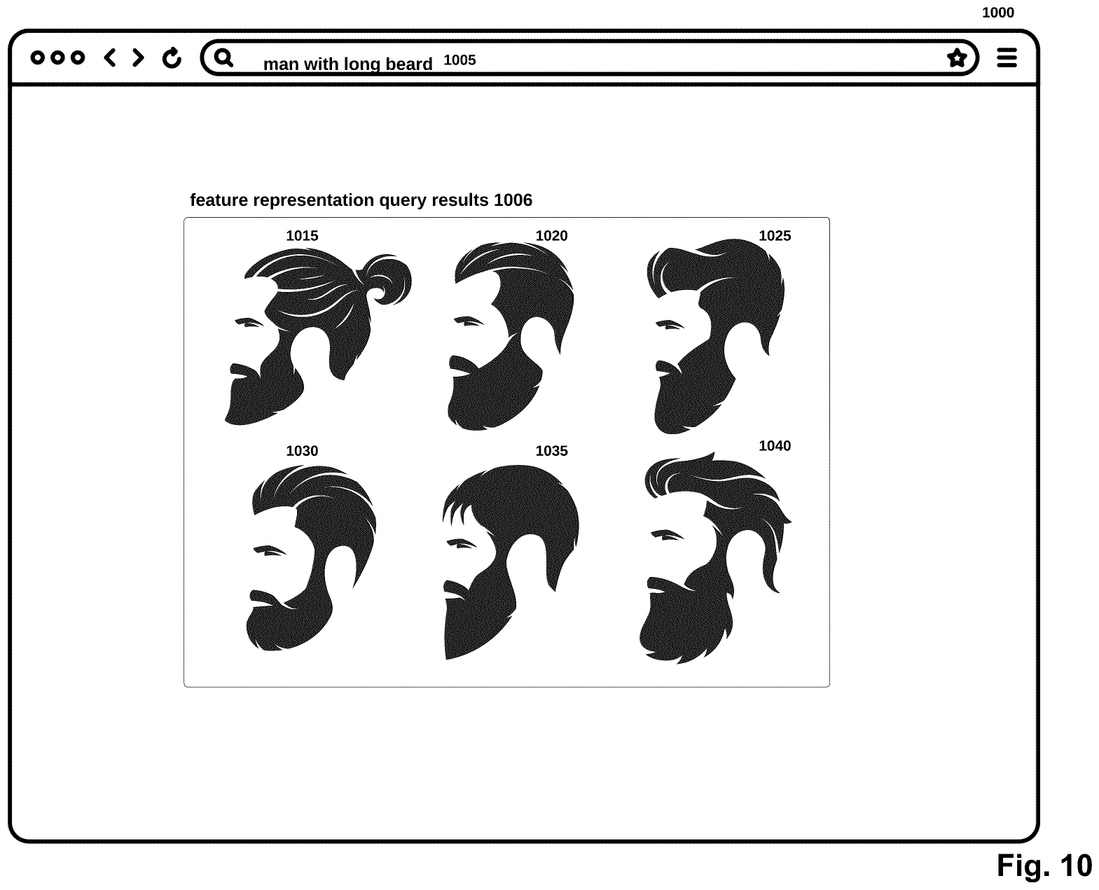

With reference to FIG. 10, one of ordinary skill in the art may appreciate the search results 1006 as corresponding to a query performed the customer/surveillance personnel conducting an investigation. With only a description of a suspect-of-interest as having a long beard, surveillance personnel queries 1005 the system and results 1015, 1020, 1025, 1030, 1035, and 1040 are returned.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A network video recorder server comprising at least one processor, a database, and at least one memory including computer program code, the at least one memory and the computer program code configured to, with the processor, cause the network video recorder server to at least:
receive a data source, comprising at least one first moment in time and at least one first scene representation associated with a scene from a physical location corresponding to the moment in time;
preprocess the data source to transform the at least one scene representation into a representation suitable for analysis by the at least one processor;
localize one or more objects of interest from the transformed scene representation, wherein the localized one or more objects of interest comprises one or more indications;
gather the one or more indications into a scene contextualization corresponding to the at least one first scene representation associated with the data source;
generate, based at least in part on the scene contextualization, one or more intrinsic feature representations associated with the one or more indications;
identify one or more data signatures associated with the at least one first scene representation, which corresponds to a second moment in time or a second one or more scene representation, enabling the network video recorder device to associate the one or more objects of interest across the first and second at least one moments in time or the first and second at least one scene representations, the one or more data signatures based at least in part on the one or more intrinsic feature representations; and
store, via the database, the one or more data signatures, for applying the one or more intrinsic feature representations to at least one new moment in time or at least one new scene representation.

2. The network video recorder server of claim 1, wherein the at least one memory and the computer program code are further configured to, with the processor, cause the network video recorder server to:
determine if the one or more data signatures corresponds to a new object of interest associated with the at least one new moment in time or the at least one new scene representation.

3. The network video recorder server of claim 1, wherein the one or more intrinsic features are based at least in part on one or more hierarchal features generated via one or more neural networks.

4. The network video recorder server of claim 2, wherein the at least one memory and the computer program code are further configured to, with the processor, cause the network video recorder server to:
generate a notification to a user interface if the one or more data signatures is determined to correspond to the new object of interest.

5. The network video recorder server of claim 3, wherein the one or more hierarchal features further comprises one or more object attributes associated with the one or more objects of interest and one or more feature embeddings associated with the one or more objects of interest.

6. The network video recorder server of claim 5, wherein the one or more object attributes further comprises a) an object unique serial code, b) object model data, c) object maker data, and d) object color data.

7. The network video recorder server of claim 5, wherein the one or more object attributes further comprises a) upper apparel data, b) lower apparel data, c) gender data, d) facial data, e) hair data, and f) object color data.

8. A method comprising:
receiving, via at least one processor of a communication device, a data source, comprising at least one first moment in time and at least one first scene representation associated with a scene from a physical location corresponding to the moment in time; preprocessing, via the at least one processor, the data source to transform the at least one scene representation into a representation suitable for analysis;
localizing, via the at least one processor, one or more objects of interest from the transformed scene representation, wherein the localized one or more objects of interest comprises one or more indications;
gathering, via the at least one processor, the one or more indications into a scene contextualization corresponding to the at least one first scene representation associated with the data source;
generating, via the at least one processor, one or more intrinsic feature representations based at least in part on the scene contextualization and associated with the one or more indications;
identifying, via the at least one processor, one or more data signatures associated with the at least one first scene representation, which corresponds to a second moment in time or a second one or more scene representation, enabling the network video recorder device to associate the one or more objects of interest across the first and second at least one moments in time or the first and second at least one scene representations, the one or more data signatures based at least in part on the one or more intrinsic feature representations; and
storing, via the database, the one or more data signatures, for applying the one or more intrinsic feature representations to at least one new moment in time or at least one new scene representation.

9. The method of claim 8, further comprising:
determining if the one or more data signatures is corresponding to a new object of interest associated with the at least one new moment in time or the at least one new scene representation.

10. The method of claim 8, wherein the one or more intrinsic features are based at least in part on one or more hierarchal features generated via one or more neural networks.

11. The method or claim 9, further comprising:
generating a notification to a user interface if the one or more data signatures is determined to correspond to the new object of interest.

12. The method of claim 10, wherein the one or more hierarchal features further comprises one or more object attributes associated with the one or more objects of interest and one or more feature embeddings associated with the one or more objects of interest.

13. The method of claim 12, wherein the one or more object attributes further comprises a) an object unique serial code, b) object model data, c) object maker data, and d) object color data.

14. The method of claim 12, wherein the one or more object attributes further comprises a) upper apparel data, b) lower apparel data, c) gender data, d) facial data, e) hair data, and f) object color data.

15. A computer program product comprising at least one non-transitory computer readable storage medium having computer-executable program code instructions stored therein, the computer-executable program code instructions comprising:
program code instructions configured to receive a data source, comprising at least one first moment in time and at least one first scene representation associated with a scene from a physical location corresponding to the moment in time;
program code instructions configured to preprocess the data source to transform the at least one scene representation into a representation suitable for analysis by the at least one processor;
program code instructions configured to localize one or more objects of interest from the transformed scene representation, wherein the localized one or more objects of interest comprises one or more indications;
program code instructions configured to gather the one or more indications into a scene contextualization corresponding to the at least one first scene representation associated with the data source;
program code instructions configured to generate, based at least in part on the scene contextualization, one or more intrinsic feature representations associated with the one or more indications;
program code instructions configured to identify one or more data signatures associated with the at least one first scene representation, which corresponds to a second moment in time or a second one or more scene representation, enabling the network video recorder device to associate the one or more objects of interest across the first and second at least one moments in time or the first and second at least one scene representations, the one or more data signatures based at least in part on the one or more intrinsic feature representations; and
program code instructions configured to store, via the database, the one or more data signatures, for applying the one or more intrinsic feature representations to at least one new moment in time or at least one new scene representation.

16. The computer program product or claim 15, wherein the one or more intrinsic features are based at least in part on one or more hierarchal features generated via one or more neural networks, the computer program product further comprising:
program code instructions configured to determine if the one or more data signatures corresponds to a new object of interest associated with the at least one new moment in time or the at least one new scene representation.

17. The computer program product of claim 16, further comprising:
program code instructions configured to generate a notification to a user interface if the one or more data signatures is determined to correspond to the new object of interest.

18. The computer program product of claim 16, wherein the one or more hierarchal features further comprises one or more object attributes associated with the one or more objects of interest and one or more feature embeddings associated with the one or more objects of interest.

19. The computer program product of claim 18, wherein the one or more object attributes further comprises a) an object unique serial code, b) object model data, c) object maker data, and d) object color data.

20. The computer program product of claim 18, wherein the one or more object attributes further comprises a) upper apparel data, b) lower apparel data, c) gender data, d) facial data, e) hair data, and f) object color data.
